(19) United States
(12) Patent Application Publication
(10) Pub. No.: US 2018/0018940 A1
(43) Pub. Date: Jan. 18, 2018

(54) METHOD OF ADAPTING EMITTED RADIATION FROM LIGHT-EMITTING DIODES IN PIXELS OF A DISPLAY APPARATUS, AND DISPLAY APPARATUS

(71) Applicant: OSRAM Opto Semiconductors GmbH, Regensburg (DE)

(72) Inventors: Andreas Biebersdorf, Regensburg (DE); Philipp Kreuter, Regensburg (DE); Christoph Klemp, Regensburg (DE); Jens Ebbecke, Rohr In Niederbayern (DE); Ines Pietzonka, Donaustauf (DE); Petrus Sundgren, Lappersdorf (DE)

(21) Appl. No.: 15/645,060

(22) Filed: Jul. 10, 2017

(30) Foreign Application Priority Data
Jul. 15, 2016 (DE) 10 2016 113 061.3

(51) Int. Cl. G09G 5/10; G09G 3/32

(52) U.S. Cl. CPC G09G 5/10; G09G 3/32; G09G 2360/144; G09G 2360/142; G09G 2320/0693; G09G 2320/0666; G09G 2320/045; G09G 2320/0242; G09G 2320/0233; G09G 2300/026; G09G 2360/148; G09G 2320/0626

(57) ABSTRACT

A method of adapting emitted radiation from light-emitting diodes in pixels of a display apparatus, wherein the display apparatus has a multiplicity of pixels each arranged for adjustable emitted radiation of mixed light, the pixels each include at least two light-emitting diodes and, in operation, the light-emitting diodes emit in various colors so that the mixed light is composed of light of these light-emitting diodes, at least some of the pixels each include at least one light-emitting diode, which at least intermittently is operated as a photodetector and measures a brightness, by the measured brightness, an emittance of each of the affected light-emitting diodes or of the affected pixel is ascertained, and the light-emitting diodes are triggered in accordance with the ascertained emittance so that aging of the light-emitting diodes is at least partly compensated for.

### TECHNICAL FIELD

This disclosure relates to a method of adapting the emitted radiation from light-emitting diodes in pixels and a corresponding display apparatus.

### BACKGROUND

There is a need to provide a method with which aging of light-emitting diodes in a display apparatus can be compensated for so that the display apparatus emits adjustably colored light in a defined way over its service life.

### SUMMARY

We provide a method of adapting emitted radiation from light-emitting diodes in pixels of a display apparatus, wherein the display apparatus has a multiplicity of pixels, each arranged for adjustable emitted radiation of mixed light, the pixels each include at least two light-emitting diodes and, in operation, the light-emitting diodes emit in various colors so that the mixed light is composed of light of these light-emitting diodes, at least some of the pixels each include at least one light-emitting diode, which at least intermittently is operated as a photodetector and measures a brightness, by the measured brightness, an emittance of each of the affected light-emitting diodes or of the affected pixel is ascertained, and the light-emitting diodes are triggered in accordance with the ascertained emittance so that aging of the light-emitting diodes is at least partly compensated for.

We also provide a display apparatus operated by the method of adapting emitted radiation from light-emitting diodes in pixels of a display apparatus, wherein the display apparatus has a multiplicity of pixels, each arranged for adjustable emitted radiation of mixed light, the pixels each include at least two light-emitting diodes and, in operation, the light-emitting diodes emit in various colors so that the mixed light is composed of light of these light-emitting diodes, at least some of the pixels each include at least one light-emitting diode, which at least intermittently is operated as a photodetector and measures a brightness, by the measured brightness, an emittance of each of the affected light-emitting diodes or of the affected pixel is ascertained, and the light-emitting diodes are triggered in accordance with the ascertained emittance so that aging of the light-emitting diodes is at least partly compensated for, including the pixels having the light-emitting diodes and including a triggering unit arranged to measure the brightness.

We further provide a method of adapting emitted radiation from light-emitting diodes in pixels of a display apparatus, wherein the display apparatus has a multiplicity of pixels, each arranged for adjustable emitted radiation of mixed light, the pixels each include at least two light-emitting diodes and, in operation, the light-emitting diodes emit in various colors so that the mixed light is composed of light of the light-emitting diodes, all the pixels each include at least one light-emitting diode intermittently operated as a photodetector and measures a brightness, by the measured brightness, an emittance of each of the affected light-emitting diodes or of the affected pixel is ascertained, for the measurement of the brightness an external light source from outside the display apparatus is used and the external light source is natural or artificial daylight, and the light-emitting diodes are triggered in accordance with the ascertained emittance so that aging of the light-emitting diodes is at least partly compensated for.

### BRIEF DESCRIPTION OF THE DRAWINGS

FIGS. 1A and 1B through 3 and 7A and 7B show schematic sectional views of methods to trigger display apparatuses.

FIGS. 4A, 4B, 5A and 5B show schematic plan views on method steps of triggering display apparatuses.

FIGS. 6A, 6B and 6C show schematic sectional views of pixels for display apparatuses.

FIGS. 8A, 8B and 8C show schematic courses of time in triggering by methods of display apparatuses.

FIGS. 9A and 9B show schematic illustrations of a dependency of a light intensity on a current for examples of display apparatuses.

### LIST OF REFERENCE SIGNS

1 Display apparatus
2 Pixel
21 Light-emitting diode for emitting red light
22 Light-emitting diode for emitting green light
23 Light-emitting diode for emitting blue light
25 Light-emitting diode chip
26 Luminescent material
3 Light source
4 Photosensor
5 Triggering unit
6 Carrier
7 Lens
8 Shielding
9 Baffle
I Current intensity in arbitrary units (a.u.)
L Light power in arbitrary units (a.u.)
t Time
T Test radiation

### DETAILED DESCRIPTION

We provide a method that is employed in control and/or adaptation of a display apparatus. The display apparatus is a video wall, for example, or a display, for instance in a mobile phone or tablet or computer. The display apparatus can also be a clock.

The display apparatus may have a multiplicity of pixels. For instance, the display apparatus may have a resolution of at least 240×180 pixels or at least 640×480 pixels or at least 1200×900 pixels. Preferably, the pixels are arranged in a regular matrix, in particular in a rectangular or square pattern.

The pixels may be arranged for adjustable emitted radiation and/or emitted radiation intensity of mixed light. In particular, it is possible to trigger the pixels such that the pixels chronologically variably emit light having a color point within a full range of the display apparatus. Thus, it is possible for colored images to be displayed by the display apparatus in a special way as a function of time. In particular, the pixels and thus the display apparatus are arranged to display color films.

The pixels may each comprise at least two or preferably at least three light-emitting diodes. The light-emitting diodes are arranged to emit variously colored light while the display apparatus is in operation. For instance, a first one of the light-emitting diodes is arranged to generate red light, a second one of the light-emitting diodes is arranged to generate green light, and a third one of the light-emitting diodes is arranged to generate blue light. Furthermore, each color can be generated by several of light-emitting diodes in each pixel to increase redundancy in the event of the failure of individual light-emitting diodes. Thus, in operation, a mixed light is generated and emitted by the pixels and this mixed light is composed of light of the light-emitting diodes. The light-emitting diodes are preferably electrically triggerable independently of one another so that a color point of the mixed light is adjustable.

At least some of the pixels may each comprise one light-emitting diode operated at least intermittently as a photodetector. In other words, it is possible for the corresponding light-emitting diode to be turned on and operated in the reverse direction and for it to perform the function of a photodetector or solar cell. Thus, via this light-emitting diode, a brightness can be measured and/or determined.

By the measured brightness, an emittance of the applicable light-emitting diode and/or of the applicable pixel may be ascertained. The applicable light-emitting diode whose emittance is ascertained can on the one hand be the light-emitting diode itself functioning as a photodetector or, on the other hand, an adjacent light-emitting diode that shines on the light-emitting diode functioning as a photodetector. Thus, a photocurrent of the light-emitting diode used as a photodetector is preferably functionally linked with the brightness and the emittance so that by a photocurrent, a conclusion can be made in particular directly as to the brightness and preferably also as to the emittance.

The light-emitting diodes of the pixels may be triggered in accordance with the respectively ascertained emittance if the display apparatus is turned on to display still pictures or films. Thus, aging of the light-emitting diodes can be compensated for in part or completely. If the emittance of the light-emitting diodes decreases over the service life of the display apparatus, then the applicable light-emitting diodes must be operated at a higher current to generate the desired brightness.

By way of the method described here, it is accordingly possible to determine how high the increase in the operating current has become to compensate for aging and ensure consistent color quality in the reproduction of still pictures or films over the course of the service life of the display apparatus.

The method may be contemplated for adapting the emitted radiation and/or emitted radiation intensity of light-emitting diodes in pixels of a display apparatus. The display apparatus has a multiplicity of pixels, each arranged for adjustable emitted radiation and/or emitted radiation intensity of mixed light. The pixels each comprise at least two light-emitting diodes, and these light-emitting diodes emit in various colors in operation so that the mixed light is composed of light from these light-emitting diodes. At least some of the pixels each comprise at least one light-emitting diode operated at least intermittently as a photodetector and measures a brightness. By the measured brightness, an emittance of each applicable light-emitting diode and/or applicable pixel is ascertained. The light-emitting diodes of the pixels are triggered in accordance with the respectively ascertained emittance so that aging of the light-emitting diodes is compensated for at least in part.

In multichannel LED modules, various colors typically exhibit variable aging. To keep a target color point constant, however, the current emission intensity and/or efficiency and/or emittance of the individual colors for a given current must be known. The aging of the light-emitting diodes, or LEDs in short, is as a rule however not known beforehand since the aging depends both on external factors such as the length of time the particular light-emitting diode has been in operation, an ambient temperature, or external sunlight, as well as on intrinsic properties such as a position on a production wafer or epitaxial conditions that can vary locally on a wafer.

One possibility of keeping the emitted color point constant is to use color sensors in an LED module. However, then both the aging of the color sensor and a locally resolved aging of the pixels are unknown. Moreover, such a color sensor can in the normal situation not distinguish whether light coming from outside the display apparatus is adulterating the measurement.

In the method described here, conversely, at least some light-emitting diodes are used at least intermittently as a kind of solar cell. This means that the light-emitting diode used as a photodetector is switched in the reverse direction, and a photocurrent and/or photovoltage is measured. Particularly from knowledge of the power that is input and the generated photocurrent, an efficiency of the photocurrent generation can be determined. In this, the effectiveness of the photocurrent generation and the efficiency of the light generation correlates strongly with one another in the light-emitting diodes, which is particularly true in the lowest current range. Thus, the aging effects can be ascertained and corrected, for instance via a computer program and/or software.

To determine the input power, it is possible for instance to use one or more silicon detectors or a camera sensor. In particular, homogeneity of the input power is also determined throughout the display apparatus. To determine relative aging between different colors and differently emitting light-emitting diodes, the spectrum of the input light is preferably determined or at least estimated. For that purpose, a color sensor in particular, for instance for red, green and blue light, also known as an RGB sensor, is used, as are light-emitting diodes not used in the operation of the display apparatus. If light-emitting diodes are not used, then no aging or only insignificant aging occurs. Equally, light of a known spectral composition from an external or internal light source such as the sun, can be used, or a camera sensor is used to determine the input light.

Thus, compensation for aging of the light-emitting diodes in the display apparatus is efficiently achievable. Furthermore, a color point of the emitted mixed radiation can be kept very constant over the surface of the display apparatus and over time.

At least 10% or 20% or 40% or 60% of the pixels may comprise a light-emitting diode operated intermittently or permanently as a photodetector. For instance, 1/9 of all the pixels are provided with a light-emitting diode used as a photodetector so that a range of 3×3 pixels is detectable by this light-emitting diode.

The emittance of at least 90% of the pixels and/or of at least 90% of the light-emitting diodes may be ascertained. Preferably, the emittance of all the pixels and/or of all the light-emitting diodes is ascertained. Thus, accurate, fine-pixel determination of aging is possible. This requires no, or at least not many, additional components outside the actual display apparatus.

80% or 90% or all of the pixels may comprise a light-emitting diode operated intermittently or permanently as a photodetector. The current emittance of all the pixels, and preferably of at least 60% or 90% or of all the light-emitting diodes, is thus ascertainable.

Some or all of the light-emitting diodes may be operated intermittently as a photodetector. Moreover, preferably the same fraction or all of the light-emitting diodes intermittently emit light as intended and contribute to the mixed light emitted by the pixels. In other words, a fraction or all of the light-emitting diodes are used intermittently both to generate the mixed light and intermittently determine the emittance and thus compensate for aging.

The light-emitting diode or light-emitting diodes operated at least intermittently as the photodetector do not necessarily contribute to the emitted radiation of the mixed light. In other words, in that case, there are light-emitting diodes present that are functionalized solely as a photodetector. These light-emitting diodes are especially preferably structurally identical to the light-emitting diodes arranged to generate the mixed light. That is, the light-emitting diodes used as a photodetector and the light-emitting diodes provided for radiation generation are indistinguishable from one another for instance in terms of their semiconductor layer sequence and/or externally, and they preferably differ from one another solely in the electrical functionalization.

The light-emitting diodes themselves may be used at least intermittently as a light source for a test radiation to measure the brightness. In other words, some of the light-emitting diodes emit light while, conversely, some others of the light-emitting diodes at the same time are functionalized as a photodetector. Preferably at a specific time, a unique association such as a 1:1 association, respectively exists between the emitting light-emitting diodes and the light-emitting diodes operated as a photodetector. Thus a measurement of the brightness is made possible purely within the display apparatus.

The light-emitting diodes may themselves be used at least intermittently as a light source for the test radiation for measuring the brightness. In other words, some of the light-emitting diodes emit light while, conversely, some others of the light-emitting diodes at the same time are functionalized as a photodetector. The emission intensity of the emitting light-emitting diodes is varied in a chronologically defined way. By filtering out the intensity in the photocurrent of the light-emitting diodes functionalized as a photodetector that have the same chronological signature, an interfering effect of external light sources can be eliminated, for instance by using a chopper process or a lock-in process.

In the measurement of brightness, at least one calibration image may be displayed by the display apparatus. Preferably, several calibration images are displayed at brief time intervals one after another, in order at specific times to enable operating various light-emitting diodes as a photodetector and as emission units. The calibration image is, for example, a test pattern or a starting image when the display apparatus is being turned on. For instance, the calibration image or images can be starting images for when the device in which the display apparatus is used is booted.

To measure the brightness, an external light source from outside the display apparatus may be used either sometimes or all the time. The external light source can be natural or artificial light, and in particular daylight. For example, sunlight is used as the external light source. In artificial daylight, the light from fluorescent lamps or incandescent lamps or external LED lamps can be used.

The display apparatus may comprise at least one photosensor. The photosensor differs from the light-emitting diodes that serve at least intermittently as photodetectors. For example, the photosensor is based on the different semiconductor material from the light-emitting diodes, and it involves one or more silicon diodes, for example. The photosensor may be an individual sensor or a sensor array such as a CCD chip. The photosensor is structurally different from the light-emitting diodes and in particular is made from an indirect semiconductor material so that the photosensor is not arranged to emit light, in contrast to the light-emitting diodes functionalized as a photodetector.

Having the at least one photosensor, a spectral composition of radiation from outside the display apparatus may be determinable, or approximately determinable. For instance, the photosensor is a camera or a color sensor with which the spectral composition of the external light source and thus the test radiation can be ascertained. It is not absolutely required that the spectrum of the test radiation be determined or measured continuously. On the contrary, it is preferably sufficient if the spectral composition of the test radiation is precisely known in various spectral partial ranges, for instance in excerpts from the blue, green and red spectral range.

In the measurement of brightness, it may be taken into account whether all or only some of the pixels are exposed to the external light source. For instance, it is possible for some of the pixels to be shaded from the external light source by an external barrier. This can be taken into account by suitable evaluation software.

The light-emitting diodes inside the pixels may be based on different semiconductor materials. In that case, the light-emitting diodes are preferably free of a luminescent material that varies a wavelength of a light emitted directly by a light-emitting diode chip. In particular, one light-emitting diode for direct generation of red light, one further light-emitting diode for direct generation of green light, and one further light-emitting diode for direct generation of blue light are present. The light-emitting diode that generates red light is based for instance on the material system InAlGaAs, while the light-emitting diodes that generate green and blue light can be based on the material system AlInGaN; preferably, different indium contents are present.

The light-emitting diodes inside the pixels, or all the pixels jointly, each may have structurally identical light-emitting diode chips. For example, this involves light-emitting diode chips that emit blue light or near-ultraviolet radiation based on the material system AlInGaN and which, within the production tolerances, generate light of the same spectral composition. In that case, at least two of the light-emitting diodes or three of the light-emitting diodes within the pixels comprise one or more luminescent materials. As a result, despite structurally identical light-emitting diode chips, one light-emitting diode for generating red light, one light-emitting diode that generates green light, and one light-emitting diode that generates blue light can be constructed.

At least one of the light-emitting diodes may comprise two structurally identical light-emitting diode chips and one luminescent material. The luminescent material is jointly downstream of the light-emitting diode chips. Furthermore, the luminescent material is preferably arranged for full wavelength conversion so that no radiation generated directly by the light-emitting diode chips leaves the applicable light-emitting diode. The light-emitting diode chips here serve each other as a light source for measuring the brightness. Thus, the amount of luminescent material is preferably less between the adjacent light-emitting diode chips than toward the outside.

Triggering the light-emitting diodes may take place such that the aging is compensated for. Emitted light intensities of the light-emitting diodes remain constant, at least relative to one another, over the service life of the display apparatus. This is preferably true with a tolerance of at most 10% or 5% or 2% or 1%. Preferably, a color point thus remains defined and/or constant over the service life of the display apparatus except for a one- or two-step MacAdams ellipse. Alternatively or in addition, this deviation is at most 0.01 units in the U′V′-CIE color diagram. Without such a correction, a color deviation can occur at a three-step MacAdams ellipse or a four-step MacAdams ellipse. Because of aging effects, it is possible for individual light-emitting diodes, over the service life of the display apparatus, to suffer a power loss on the order of magnitude of 30% or 40%, referred to a fixed operating current intensity.

The light-emitting diodes may be triggered with a modified pulse width modulation or bit angle modulation, or BAM for short. The brightness is preferably measured within this modulation.

The brightness, for measuring the emittance, may be measured at most every two hours or every four hours or every ten hours or every hundred hours. It is possible within the first 100 or 500 operating hours of the display apparatus to use a shorter time interval between successive brightness measurements than in later operation of the display apparatus. For instance, after 500 hours of operation of the display apparatus, a measurement of the brightness is made at most every 100 hours or 500 hours or 1000 hours. The time intervals between adjacent measurements of the brightness can relate to a time in operation of the display apparatus or to actual elapsed time.

The light-emitting diodes which are functionalized as a photodetector may be lighted with a test radiation of a known spectral composition. This can be the external light source that emits a defined or approximately defined spectrum. In the same way, adjacent light-emitting diodes, whose spectral composition is known with respect to the test radiation, can serve as a light source.

Adjacent light-emitting diodes may be coupled optically to one another. This can mean that a relative proportion of the emitted radiation of at least 10⁻⁵ or 10⁻⁴ and/or of at most 10⁻² or 10⁻³, that reaches the adjacent light-emitting diode functionalized intermittently or permanently as a photodetector, suffices. In other words, the optical coupling between the emitting light-emitting diodes and the light-emitting diodes used as a photodetector is comparatively weak so that external efficiency is unimpaired or not significantly impaired. If an external light source is used for brightness measurement, then it is possible for the light-emitting diodes to be optically isolated from one another in the pixels.

We also provide a display apparatus. The display apparatus is operated at least intermittently by a method as disclosed in conjunction with one or more of the aforementioned examples. Therefore, features of the method are disclosed for the display apparatus as well, and vice versa.

The display apparatus may comprise a triggering unit. The at least one triggering unit is arranged to measure the brightness. To that end, a current and/or a voltage is preferably applied to the light-emitting diodes functionalized as a photodetector, preferably intermittently in the reverse direction, or alternatively or in addition the photocurrent and/or the photovoltage is measured. In other words, the triggering unit is not a conventional current source for light-emitting diodes.

The display apparatus may be a video wall. This means that the pixels are arranged in a relatively wide grid dimension and/or are spaced far apart from one another. For instance, the mean grid dimension in which the pixels are arranged amounts to at least 2 mm or 5 mm or 12 mm and/or at most 0.2 m or 0.1 m or 6 cm. Such video walls may be appropriate for instance as display boards or advertising surfaces on buildings, in sports stadiums, or at transport nodal points.

Below, a method described here and a display apparatus described here will be explained in further detail with reference to the drawing in terms of examples. The same reference numerals indicate the same elements in the individual drawings. However, no references to scale are shown; instead, individual elements may be shown as exaggeratedly large for the sake of better comprehension.

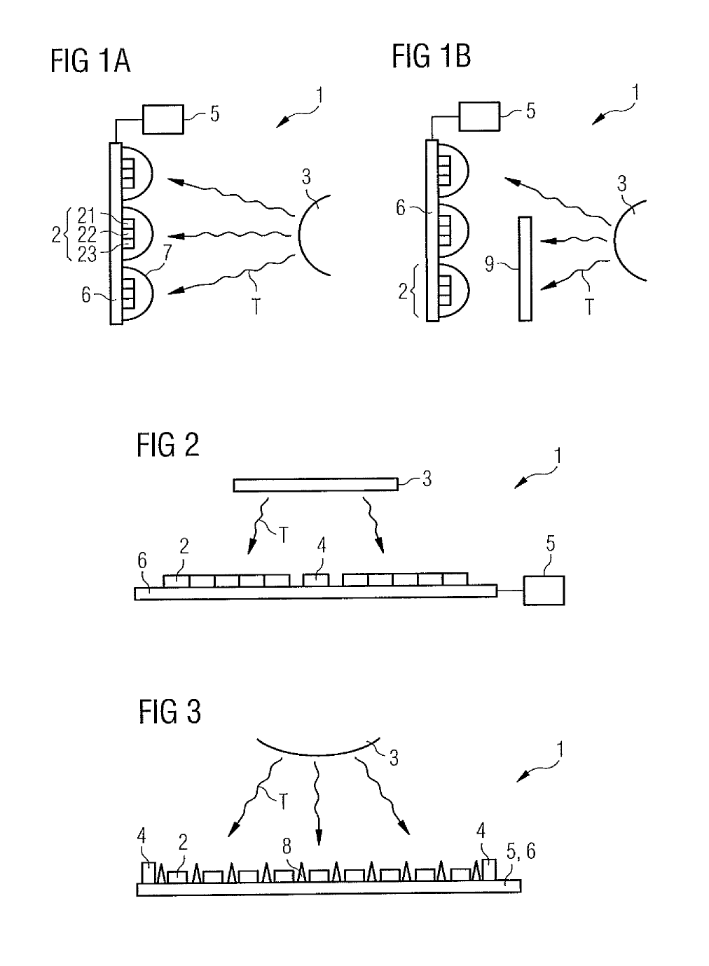

In FIG. 1, one example of a display apparatus 1 is shown. The display apparatus 1 comprises a multiplicity of pixels 2 arranged to emit light of various colors as a function of time. By way of the pixels 2, a still picture or a film can be displayed.

The pixels 2 each have a first light-emitting diode 21 to emit red light, a second light-emitting diode 22 to emit green light, and a third light-emitting diode 23 to emit blue light. The light-emitting diodes 21, 22, 23 are located side by side on a carrier 6. Optionally, the light-emitting diodes 21, 22, 23 can be followed individually or, as shown in FIG. 1, jointly, by a lens 7.

Depending on a given individual time in operation, on the material system on which the various light-emitting diodes 21, 22, 23 are based, or depending on external environmental factors such as sunlight, the light-emitting diodes 21, 22, 23 are subject to various amounts of aging. Over the service life of the display apparatus 1 to generate films or still pictures with high color quality, the aging behavior of the light-emitting diodes 21, 22, 23 must be compensated for.

For that purpose, the light-emitting diodes 21, 22, 23 serve intermittently as a photodetector. Functionalization as a photodetector is effected via the triggering unit 5, which is arranged on the one hand to supply current to the light-emitting diodes 21, 22, 23 to emit a mixed radiation from the individual pixels 2. On the other hand, the triggering unit 5 is arranged so that at least some or all of the light-emitting diodes 21, 22, 23 can be operated intermittently or permanently as photodetectors so that, via the triggering unit 5, a photovoltage and/or a photocurrent of the light-emitting diodes 21, 22, 23 is measurable.

In FIG. 1A, the pixels 2 with the light-emitting diodes 21, 22, 23 are illuminated by an external light source 3 with a test radiation T. The test radiation T preferably has a known spectral composition. The test radiation T is, for example, sunlight. To more precisely define the spectral composition of the test radiation T, the illumination is effected with the test radiation T, for instance at a particular time of day, for instance taking weather conditions and/or the time of year into account.

If the display apparatus 1 is a video wall, for instance, then in addition further parameters can be taken into account, for instance in emitting the spectral composition of the test radiation T. Examples of such further parameters are an installation location, a stadium lighting situation, or indoor lighting in a large public space. The same is correspondingly true for other macroscopic applications, that is, display apparatuses that have a relatively large surface area. Conversely, in microscopic applications such as smartphone displays, it is possible to measure the test radiation T using a camera in the front, for example.

By the test radiation T, a certain photocurrent and/or photovoltage is generated in the light-emitting diodes 21, 22, 23. This photocurrent or photovoltage is measured via the triggering unit 5. The photocurrent or photovoltage generated is correlated with an emittance of the light-emitting diodes 21, 22, 23. Thus by way of the intermittent functionalization of the light-emitting diodes 21, 22, 23 as photodetectors, it is possible to ascertain how severely they have aged and how efficiently they emit radiation at a defined operating current.

If, for example, a smaller photocurrent is generated, then typically a reduced emittance of the applicable light-emitting diode must be assumed. By the illumination with the test radiation T and the associated brightness measurement by ascertaining the photocurrent or photovoltage, a correction value can thus be ascertained by way of which the supply of current to the light-emitting diodes 21, 22, 23 by the triggering unit 5 can be reregulated so that the individual pixels 2 emit with a desired brightness and/or color. The emittance of the light-emitting diodes 21, 22, 23 can be determined absolutely, or only relatively to one another so that a color point, but not necessarily the absolute brightness, can be adjusted as desired.

FIG. 1B shows that some of the pixels 2 are shielded from the test radiation T by a baffle 9, for instance a natural barrier. Preferably, such unwanted dimming of the test radiation T is ascertainable by the triggering unit 5, for instance because the applicable shielded pixels 2 and the associated light-emitting diodes 21, 22, 23 experience significantly reduced brightness. At least in such pixels 2 shielded by the baffle 9, determining the aging is done at a later time, preferably whenever all the pixels 2 are exposed to the test radiation T again.

In the example of FIG. 2 as well, the external light source 3 is present. The external light source 3 is formed, for example, by an artificial lighting system such as fluorescent tubes.

A photosensor 4, for instance a silicon diode and/or a color sensor, is mounted on the carrier 6. Via the additional photosensor 4, which is not arranged to emit light, an intensity and/or spectral composition of the test radiation T can be ascertained. Hence, via the photosensor 4 the properties of the test radiation T can become known. Thus, the efficiency of the light-emitting diodes in the pixels 2 in the generation of the photocurrent and/or photovoltage can also be determined, and a conclusion about the aging can be drawn. Appropriate evaluation software can be located in the triggering unit 5 or in an external regulating unit, not shown, such as a computer; this regulating unit is preferably arranged for outputting control signals to display the still pictures or films.

In FIG. 2, the photosensor 4 is located centrally in the display apparatus 1, and the pixels 2 are located in several fields around the photosensor 4. Alternatively, it is possible for the photosensor 4 to be located on one edge of the display apparatus 1 as seen in FIG. 3. The photosensor 4 is, as an example, a camera chip, for instance in a mobile phone or in a tablet. The photosensor 4 can also be formed by a so-called webcam. As in all the other examples, it is possible for the signals of the photosensor 4 not to go directly to the triggering unit 5, but instead for further components, not shown such as a cable-free data transmission device to be placed in between.

In the example of FIG. 3, a plurality of the photosensors 4 are present. Via a plurality of photosensors 4, it is possible to ascertain whether the test radiation T is being shone in via the display apparatus 1. The external light source 3 is once again the sun, for example.

As in the examples of FIGS. 1 and 2, it is also possible for optical shields 8 to be located each between adjacent pixels 2. As a result light from a pixel 2 can be prevented from reaching an adjacent pixel 2. Corresponding shields 8 can also be located between the photosensors 4 and the adjacent pixels 2.

Such photosensors 4, as illustrated in FIGS. 2 and 3, can also be present in all of the other examples.

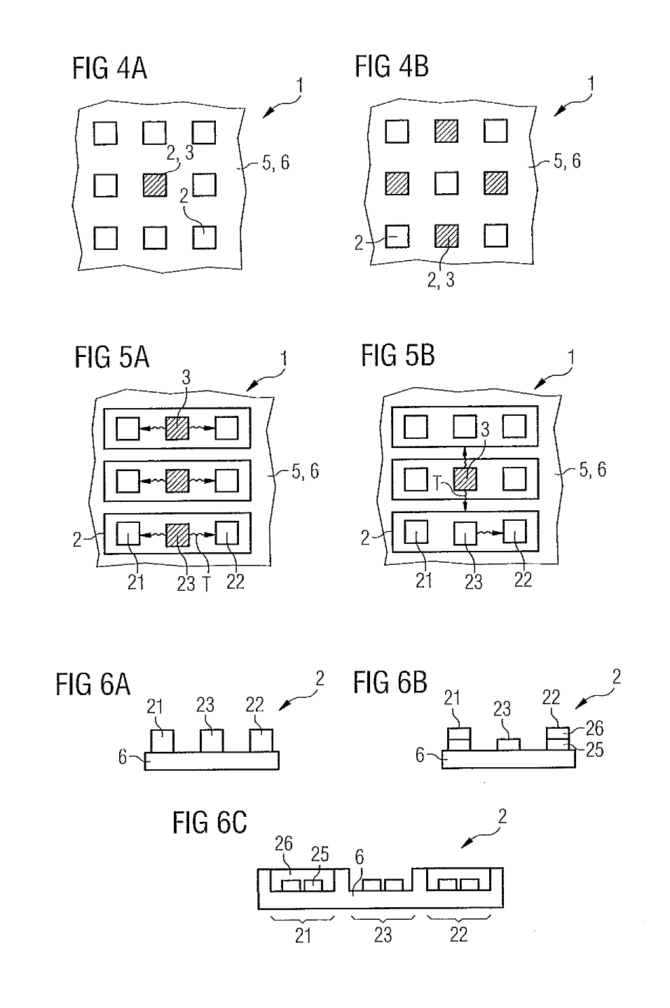

In the display apparatus 1 of FIG. 4A, one of the pixels 2, or at least one of the light-emitting diodes of this pixel 2, simultaneously serves as an internal light source 3. By this internal light source 3, for instance all the eight pixels 2 surrounding it, or alternatively light-emitting diodes, can be illuminated intermittently. Since it is known what the spectral composition of the pixels 2 is that is emitted as a test radiation T, in this case an additional photosensor can be dispensed with.

In FIG. 4B, it is shown that other pixels 2 serve intermittently as an internal light source 3. Thus, the central pixel in FIG. 4B as well, which in FIG. 4A served as an internal light source 3, can be operated intermittently as a photodetector. Thus, all the pixels 2 can be measured with respect to their aging.

The patterns shown in FIG. 4 are merely examples. Patterns of internal light sources 3 that deviate from this can also be used.

In FIG. 5, the pixels 2 are shown in more detail. In FIG. 5A, there is a central, third light-emitting diode 23 that emits blue light. This blue light serves as the test radiation T and is absorbed in both the first light-emitting diodes 21 and the second light-emitting diodes 22 and is converted into a photocurrent or photovoltage. Thus, aging can be determined inside the pixels 2. Since the light-emitting diodes 22, 23 are preferably based on the same material system such as AlInGaN, it is optionally also possible, from the aging of the second light-emitting diode 22, to draw a conclusion about the aging of the third light-emitting diode 23. The first light-emitting diode 21 is based on the material system AlInGaAs, for example.

In FIG. 5B, it is shown that the third, central, light-emitting diode 23 can be used as a light source 3 spanning more than one pixel, in particular as the third light emitting diodes 23 of the pixels 2 directly adjacent.

In FIG. 6, examples are shown for designs of the pixels 2. In FIG. 6A, the light-emitting diodes 21, 22, 23 are formed by light-emitting diode chips, based on different material systems. The light-emitting diodes 21, 22, 23 are free of a luminescent material.

In FIG. 6B, the light-emitting diodes 21, 22, 23 each have a structurally identical light-emitting diode chip 25. Different luminescent materials 26 are downstream of the light-emitting diodes 21, 22 so that red, green and blue light can all be generated. If the light-emitting diode chips 25 are light-emitting diode chips that emit near-ultraviolet light, a luminescent material, not shown, to generate blue light is preferably downstream of the third light-emitting diode 23.

In FIG. 6C, the individual light-emitting diodes 21, 22, 23, or at least some of the light-emitting diodes 21, 22, 23 each comprise a plurality of the light-emitting diode chips 25, in particular two such chips. Furthermore, at least the light-emitting diodes 21, 22 are each provided with a luminescent material 26. All the light-emitting diode chips 25 are preferably structurally identical and in particular emit blue light. Via the luminescent material 26, toward the outside a complete conversion of the blue light into light of some other color takes place, as is preferable in the example of FIG. 6B as well. A luminescent material layer thickness toward the outside here is greater than between the adjacent light-emitting diode chips 25 inside the light-emitting diodes 21, 22 so that the light-emitting diode chips 25 inside one of the light-emitting diodes 21, 22 can serve one another mutually as a light source for determining the aging.

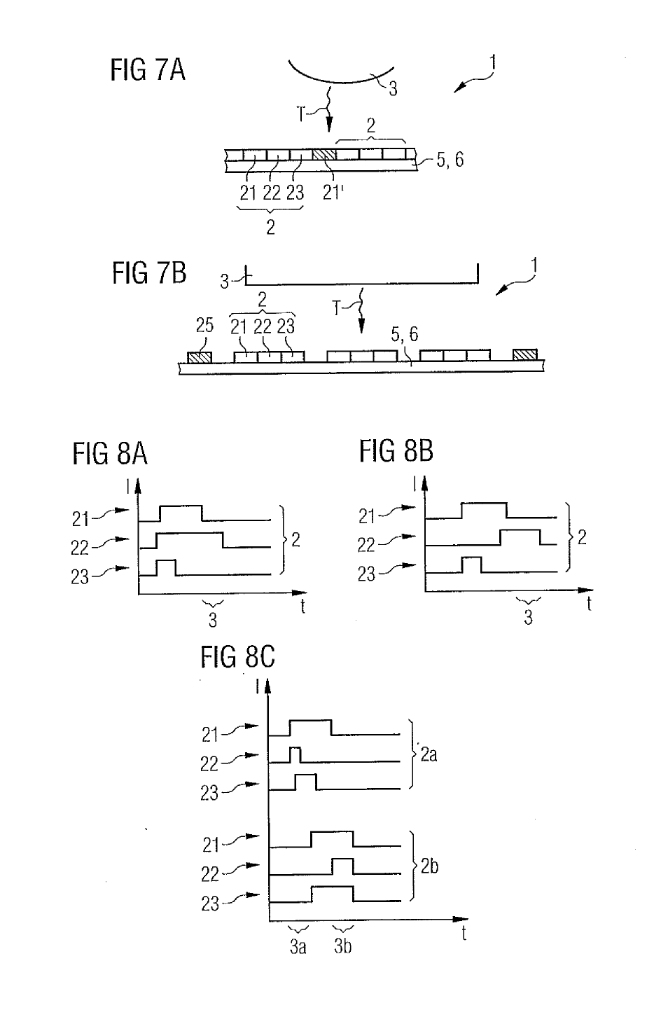

According to FIGS. 1 through 6, certain light-emitting diodes 21, 22, 23 intermittently generate the emitted light and intermittently as a photodetector. By comparison, in FIG. 7A, a plurality of additional light-emitting diodes 21′ are present, which are structurally identical to one of the light-generating light-emitting diodes 21, 22, 23. The additional light-emitting diodes 21′ serve exclusively as a photodetector and are not provided for light generation. Thus, the additional light-emitting diodes 21′ do not age, or do not age significantly, and can serve as a reference in the determination of the emittance of the light-generating light-emitting diodes 21, 22, 23. Unlike what is shown in FIG. 7A, an internal light source as in FIG. 4 or FIG. 5 can also be used.

In FIG. 7A, the additional light-emitting diodes 21′ are integrated directly into the arrangement of the pixels 2. In a deviation from this, the additional light-emitting diodes 21′ in FIG. 7B are formed by the light-emitting diode chips 25 separated from the pixels 2. Otherwise, FIG. 7B is equivalent to FIG. 7A.

In FIG. 8, current intensities I are illustrated schematically as a function of the time t. The light-emitting diodes 21, 22, 23 are operated by pulse width modulation, or PWM for short, or bit angle modulation, or BAM for short.

In FIG. 8A, the light-emitting diodes 21, 22, 23 are turned on at the beginning of a time slot of the modulation. For example, if the third light-emitting diode 23 is operated for a longer time than the remaining light-emitting diodes 21, 22, then the third light-emitting diode 23 can serve as a light source 3 in a particular time slot.

In FIG. 8B, the time slot in which the third light emitting diode 23 is operated is shifted toward one end of a modulation period. Thus at the end of the applicable modulation period, there is a time slot in which the third light-emitting diode 23 can serve as a light source 3.

In FIG. 8C, different pixels 2a, 2b are operated with different modulation. For example, the light-emitting diodes 21, 22, 23 of the pixel 2a are turned on at the beginning of a modulation period, and the light-emitting diodes 21, 22, 23 of the pixel 2b are turned on at the end of a modulation period. Thus, it is possible for the pixel 2a to serve as a light source 3a at the beginning of the modulation period and for the pixel 2b to serve as a light source 3b at the end of the modulation period. Corresponding methods can also be applied to more than one or two pixels 2. It is possible for a measurement of the aging and thus the brightness of the light-emitting diodes 21, 22, 23 to take place during every modulation period, but preferably not during each modulation period of the PWM or BAM. Instead, it takes place only at comparatively long time intervals. For the brightness determination, test pictures or calibration images can be used.

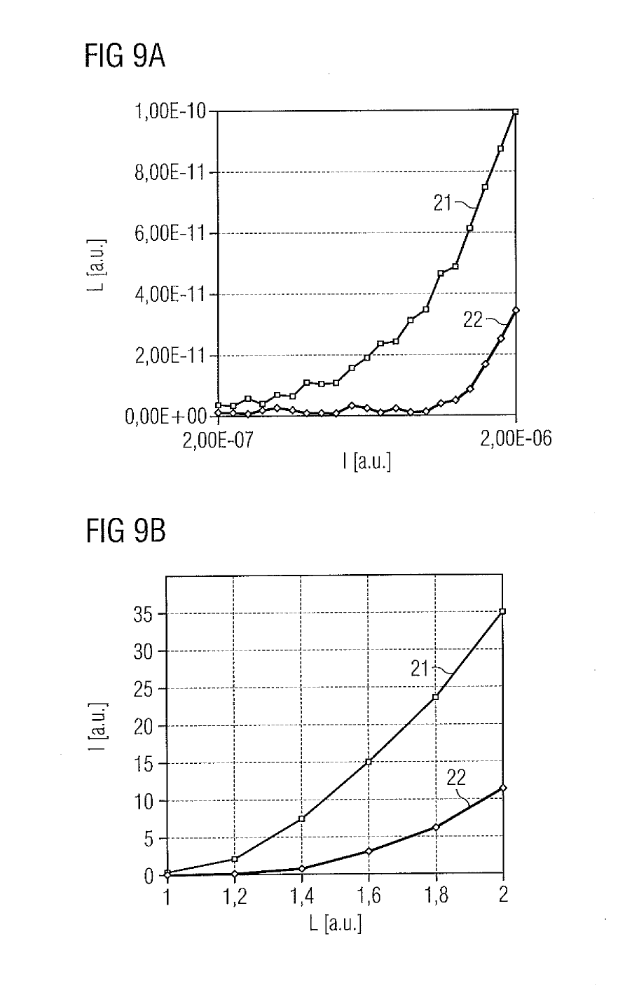

In FIG. 9, the dependency of the emittance on an efficiency for generating a photocurrent is illustrated schematically. In FIG. 9A, as an example, an operating current I is plotted in arbitrary units, and dependent on it, a light power L is plotted, again in arbitrary units. The two exemplary light-emitting diodes 21, 22 have different emittances.

In FIG. 9B, a photocurrent I as a function of the light power L is shown for the same light-emitting diodes 21, 22. It can be seen that the emittance of the light-emitting diodes 21, 22 is correlated with the efficiency in the generation of the photocurrent; see FIG. 9B. Thus, the emittance in the operation of the light-emitting diodes 21, 22 can be determined by the measurement of the photocurrent.

Of course, if the light-emitting diodes 21, 22, 23 are driven by PWM or BAM, longer current application times can be regarded as equivalent to a higher current. That is, for PWM or BAM a mean current can be increased although when using a constant current source.

Our methods and apparatus are not limited by the description provided with reference to the examples. Rather the disclosure encompasses any novel feature and any combination of features, including in particular any combination of features in the appended claims, even if this feature, or this combination itself, is not explicitly stated in the claims or examples.

This application claims priority of DE 10 2016 113 061.3, the subject matter of which is incorporated by reference.

1. A method of adapting emitted radiation from light-emitting diodes in pixels of a display apparatus, wherein
the display apparatus has a multiplicity of pixels each arranged for adjustable emitted radiation of mixed light,
the pixels each comprise at least two light-emitting diodes and, in operation, the light-emitting diodes emit in various colors so that the mixed light is composed of light of these light-emitting diodes,
at least some of the pixels each comprise at least one light-emitting diode, which at least intermittently is operated as a photodetector and measures a brightness,
by the measured brightness, an emittance of each of the affected light-emitting diodes or of the affected pixel is ascertained, and
the light-emitting diodes are triggered in accordance with the ascertained emittance so that aging of the light-emitting diodes is at least partly compensated for.

2. The method according to claim 1, wherein at least 10% of the pixels comprise a light-emitting diode intermittently operated as a photodetector so that emittance of at least 90% of the pixels and of at least 90% of the light-emitting diode is ascertained.

3. The method according to claim 2, wherein all the pixels comprise a light-emitting diode operated intermittently as a further photodetector so that the emittance of all the pixels and of at least 90% of the light-emitting diodes is ascertained.

4. The method according to claim 1, wherein all the light-emitting diodes are operated intermittently as a photodetector and intermittently emit light.

5. The method according to claim 1, wherein the light-emitting diode, which is operated at least intermittently as a photodetector, does not contribute to the emitted radiation of the mixed light.

6. The method according to claim 1, wherein, as a light source for a test radiation to measure the brightness, at least intermittently the light-emitting diodes themselves are used, and the light-emitting diodes are operated with intensity modulation to measure the brightness so that the influence of external light sources on the measurement is minimized.

7. The method according to claim 6, wherein, in the measurement of the brightness by the display apparatus, a calibration image is displayed.

8. The method according to claim 1, wherein, for the measurement of the brightness, at least intermittently an external light source from outside the display apparatus is used.

9. The method according to claim 8, wherein the external light source is natural or artificial daylight.

10. The method according to claim 9, wherein the display apparatus comprises at least one photosensor different from the light-emitting diodes, and with the photosensor, a spectral composition of radiation of the external light source at least in spectral subregions is determined, and in the measurement of the brightness, attention is paid to whether all the pixels are exposed to the external light source.

11. The method according to claim 1, wherein the light-emitting diodes within the pixels are based on different semiconductor materials and generate red, green and blue light in a manner free of luminescent material.

12. The method according to claim 1, wherein the light-emitting diodes within the pixels each have structurally identical light-emitting diode chips, and at least two of the light-emitting diodes comprise a luminescent material so that all in all, red, green and blue light is generated.

13. The method according to claim 12, wherein at least one of the light-emitting diodes comprises two structural identical light-emitting diode chips and a luminescent material for complete wavelength conversion, and the light-emitting diode chips mutually serve as a light source in the measurement of the brightness.

14. The method according to claim 1, wherein the triggering of the light-emitting diodes compensates for aging so that emitted light intensities of the light-emitting diodes remain constant relative to one another over a service life of the display apparatus, with a tolerance of at most 5%.

15. The method according to claim 1,
wherein the light-emitting diodes are triggered with a modified pulse width modulation or bit angle modulation, and the brightness is measured within this modulation, and
the brightness is measured on average at most every two hours.

16. A display apparatus operated by the method according to claim 1, comprising the pixels having the light-emitting diodes and comprising a triggering unit arranged to measure the brightness.

17. The display apparatus according to claim 16, which is a video wall, wherein a mean grid dimension of the pixels amounts to at least 2 mm and at most 0.1 m.

18. A method of adapting emitted radiation from light-emitting diodes in pixels of a display apparatus, wherein
the display apparatus has a multiplicity of pixels each arranged for adjustable emitted radiation of mixed light,
the pixels each comprise at least two light-emitting diodes and, in operation, the light-emitting diodes emit in various colors so that the mixed light is composed of light of the light-emitting diodes,
all the pixels each comprise at least one light-emitting diode intermittently operated as a photodetector and measures a brightness,
by the measured brightness, an emittance of each of the affected light-emitting diodes or of the affected pixel is ascertained,
for the measurement of the brightness an external light source from outside the display apparatus is used and the external light source is natural or artificial daylight, and
the light-emitting diodes are triggered in accordance with the ascertained emittance so that aging of the light-emitting diodes is at least partly compensated for.
